(19) United States
(12) Patent Application Publication
(10) Pub. No.: US 2006/0262120 A1
(43) Pub. Date: Nov. 23, 2006

(54) Ambulatory based human-computer interface

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: Outland Research, LLC, Pismo Beach, CA (US)

(21) Appl. No.: 11/367,178

(22) Filed: Mar. 2, 2006

Related U.S. Application Data
(60) Provisional application No. 60/683,020, filed on May 19, 2005.

(51) Int. Cl. G06T 15/70

(52) U.S. Cl. 345/473

(57) ABSTRACT

A human computer interface system includes a user interface having sensors adapted to detect footfalls of a user's feet and generate corresponding sensor signals, a host computer communicatively coupled to the user interface and adapted to manage a virtual environment containing an avatar associated with the user, and control circuitry adapted to control the avatar within the virtual environment to perform one of a plurality of virtual activities based at least in part upon at least one of a sequence and timing of detected footfalls of the user. The virtual activities include at least two of standing, walking, jumping, hopping, jogging, and running. The host computer is further adapted to drive a display to present a view to the user of the avatar performing the at least one virtual activity within the virtual environment.

This application claims the benefit of U.S. Provisional Application No. 60/683,020, filed May 19, 2005, which is incorporated in its entirety herein by reference.

### BACKGROUND

1. Field of Invention

Embodiments disclosed herein relate generally to computer peripheral hardware used to control graphical images within a graphical simulation. More specifically, embodiments disclosed herein relate to computer input apparatus and methods facilitating user input of commands into a computer simulation by walking, running, jumping, hopping, climbing stairs, and/or pivoting side to side, etc., in place, thereby facilitating control of a graphical character to perform similar actions.

2. Discussion of the Related Art

Traditional computer peripheral hardware includes manually operable devices such as mice, joysticks, keypads, gamepads, and trackballs. They allow users to control graphical objects by manipulating a user object that is tracked by sensors. Such devices are effective in manipulating graphical objects and navigating graphical scenes based on small hand motions of the user. Such devices are useful for controlling simple video games or controlling the cursor in a software application, but they are not effective in providing a realistic means of interaction in immersive simulation environments. An avatar can be an animated human figure that can walk, run, jump, and otherwise interact within the virtual environment in natural ways. Typically, such an avatar is controlled by the user in a “first person” perspective. In other words, as the avatar navigates the virtual environment, the user controlling the avatar is given the perspective of actually “being” that avatar, seeing what the avatar sees. Such an environment could include multiple avatars, each controlled by a different person, all networked to the same environment over the Internet.

Prior art systems allow users to control avatars and navigate virtual environments, a joystick or mouse or keypad or gamepad is used to control the avatar. For example, if a user wants to cause his or her avatar to walk forward, a button would be pressed or a mouse would be moved to create the motion. The act of pressing a button to causing walking of a graphical avatar, however, is not a realistic physical expression for the user.

In general, prior art systems do not allow users to control the gait based activities of avatars such as walking, running, jumping, stepping, and hopping, based upon natural and physically similar motions of the user. One system that is directed at the control of avatars through foot-based motion is U.S. Pat. No. 5,872,438 entitled “Whole Body Kinesthetic Display” to Roston. This system appears to allow a user to walk upon computer controlled movable surfaces that are moved in physical space by robotic actuators to match a users foot motions. While this ambitious system does enable the control of a computer simulation, it has significant limitations of being extremely large, extremely expensive, highly complex, consumes significant power, consumes significant processing resources, and puts the user into the dangerous position of standing high upon two large robotic actuators that could have the potential to cause bodily harm. In addition, while this device is directed at simulating interaction with a wide variety of terrain configurations, the device does not disclose computational methods for sensing, processing, and distinguishing between common human locomotion activities based upon detected footfalls such as walking, jogging, running, hopping, and jumping. Finally, while this device appears to be directed at military simulations in which a large physical space can be devoted to the required equipment, it is not practical for applications such as a home, office, or gym. What is therefore needed is a small and inexpensive system for interfacing a user to a computer simulation that can sense user gait motion, distinguish between common locomotion activities such as walking, jogging, running, hopping, and jumping, and can control a simulated avatar accordingly. What is also needed are computational methods by which human gait-based activities can be determined and quantified through the sensing and timing of footfall events and not based upon the positional tracking of continuous foot motion, thereby decreasing the computational burden of the interface and reducing the complexity of the required hardware, software, and electronics.

### SUMMARY

Several embodiments exemplarily disclosed herein advantageously address the needs above as well as other needs by providing an ambulatory based human-computer interface.

One embodiment exemplarily described herein provides a human computer interface system that includes a user interface having sensors adapted to detect footfalls of a user's feet and generate corresponding sensor signals. A host computer is communicatively coupled to the user interface and is adapted to manage a virtual environment containing an avatar associated with the user. The system also includes control circuitry adapted to identify, from the sensor signals, a physical activity being currently performed by the user from among a plurality of physical activities based at least in part upon at least one of a sequence and a timing of detected footfalls of the user. The control circuitry is further adapted to control the avatar within the virtual environment to perform one of a plurality of virtual activities based at least in part upon the identified physical activity of the user. The host computer is further adapted to drive a display to present a view to the user of the avatar performing the virtual activity within the virtual environment. In one embodiment, the plurality of activities from which the current physical activity of the user is identified include at least two of standing, walking, jumping, hopping, jogging, and running. In another embodiment, the plurality of virtual activities the avatar can be controlled to perform within the virtual environment include at least two of standing, walking, jumping, hopping, jogging, and running.

Another embodiment exemplarily described herein provides a human computer interface method that includes steps of detecting footfalls of a user's feet with a plurality of sensors and generating sensor signals corresponding to the detected footfalls. Next, a physical activity currently performed by the user is identified based on the sensor signals. The physical activity can be identified based at least in part upon at least one of a sequence and a timing of deteced footfalls of the user. Subsequently, an avatar within the virtual environment is controlled to perfom one of a plurality of virtual activities based at least in part upon the identified current physical activity of the user. A display is then driven to present a view to the user of the avatar performing the virtual activity within the virtual environment. In one embodiment, the plurality of activities from which the current physical activity of the user is identified include at least two of standing, walking, jumping, hopping, jogging, and running. In another embodiment, the plurality of virtual activities the avatar can be controlled to perform within the virtual environment include at least two of standing, walking, jumping, hopping, jogging, and running.

Yet antoher embodiment exemplarily described herein provides a human computer interface system that includes a user interface having sensors adapted to detect footfalls of a user's feet and generate corresponding sensor signals. A host computer is communicatively coupled to the user interface and is adapted to manage a virtual environment containing an avatar associated with the user. The system also includes control circuitry adapted to control the avatar within the virtual environment to perform at least one of a plurality of virtual activities based at least in part upon at least one of a sequence and timing of detected footfalls of the user. The host computer is further adapted to drive a display to present a view to the user of the avatar performing the at least one virtual activity within the virtual environment. In one embodiment, the plurality of virtual activities the avatar can be controlled to perform within the virtual environment include at least two of standing, walking, jumping, hopping, jogging, and running.

### BRIEF DESCRIPTION OF THE DRAWINGS

The above and other aspects and features of the several embodiments described herein will be more apparent from the following more particular description thereof, presented in conjunction with the following drawings.

FIG. 1 illustrates one embodiment of an ambulatory based human-computer interface;

FIG. 2 illustrates one embodiment of the user interface shown in FIG. 1;

FIGS. 3A-3D illustrate exemplary pad sensor signals generated by pad sensors and corresponding to a plurality of exemplary physical activities of the user;

FIG. 4 illustrates another embodiment of the user interface shown in FIG. 1; and

FIG. 5 illustrates another embodiment of a user interface.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments disclosed herein. Also, common but well-understood elements that are useful or necessary in a commercially feasible embodiment are often not depicted in order to facilitate a less obstructed view of the embodiments variously disclosed herein.

### DETAILED DESCRIPTION

The following description is not to be taken in a limiting sense, but is made merely for the purpose of describing the general principles of exemplary embodiments. The scope of the embodiments disclosed herein should be determined with reference to the claims.

Numerous embodiments exemplarily disclosed herein facilitate natural navigation of a character (e.g., an avatar) through virtual environments. Such natural character navigation is facilitated upon physical exertion on behalf of the user. Accordingly, methods and apparatus exemplarily disclosed herein can be adapted to create computer entertainment and/or computer gaming experiences that purposefully provide physical exercise to users. In some embodiments, the computer entertainment and/or computer gaming experiences can be designed to provide various levels of exercise to the user as he or she controls an avatar within a virtual environment, causing that avatar to, for example, walk, run, jump, hop, climb stairs, and/or pivot side to side within the virtual environment.

In one embodiment, a user can control an avatar's walking function by performing a physical action that more closely replicates actual walking. The same is true for jogging, running, jumping, skipping, hopping, climbing, pivoting, etc. Accordingly, embodiments disclosed herein allow a user to make his/her avatar walk or run within the virtual environment by actually walking or running in place. Similarly, embodiments disclosed herein allow a user to make his/her avatar jump, hop, pivot, etc. by actually jumping, hopping, shifting his/her weight, etc., in place. These and other avatar control methods will be described in greater detail below.

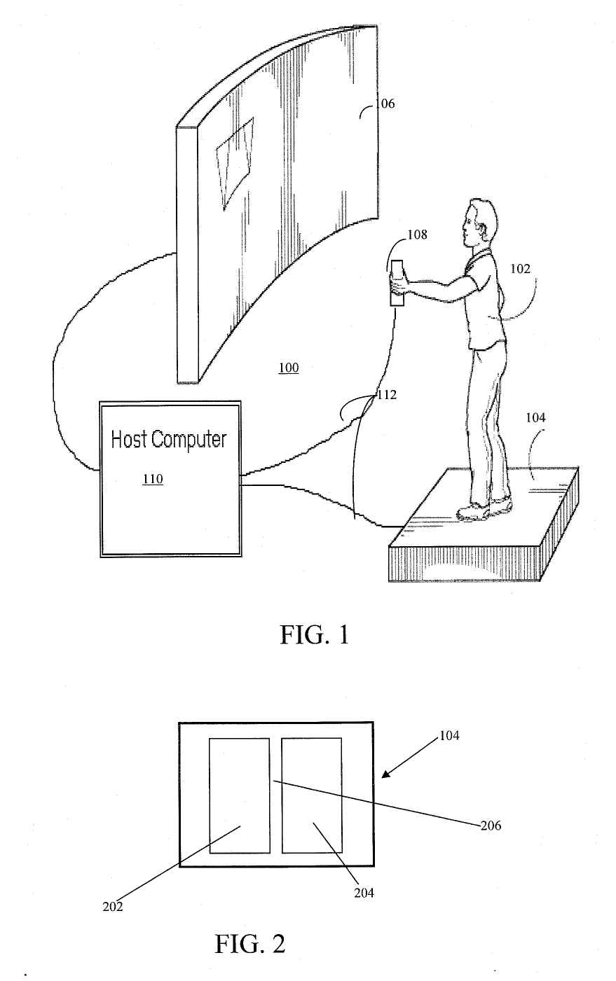

FIG. 1 illustrates one embodiment of an ambulatory based human-computer interface system. Shown in FIG. 1 are a user 102, and an ambulatory based human-computer interface system that includes a user interface 104, a display 106, a hand-piece 108, a host computer 110, and communication links 112.

Although not shown, a disable switch adapted to disable the control of the avatar via the user interface 104 may be provided, for example, on the hand-piece 108. Accordingly, the disable switch allows users to “relax” for a moment, possibly rest, or just stretch, and not spuriously cause the avatar to move within the virtual environment. In one embodiment, the disable switch may be provided as a d-pad or a hat-switch. Moreover, the hand-piece 108 may be further provided with a control such as a mini-joystick to control motion of the avatar during rest periods.

As shown in FIG. 1, a user 102 engages (e.g., stands on) a user interface 104 and looks at a graphical display 106 that is visually presenting a virtual environment to the user 102. In one embodiment, the user 102 sees the virtual environment from the point of view of an avatar that he/she is controlling via the user interface 104. The virtual environment presented to the user via the display 106 is managed by the circuitry contained within the host computer 110. The host computer 110 receives input from the user interface 104 over a communication link 112. The communication link 112 can be wired or wireless. If communication link 112 is wired (e.g., a USB connection), the user interface may also receive power over communication link 112. If communication link 112 is wireless, the user interface can be battery powered or have a separate power line to the wall. The user 102 also holds a hand-piece 108. Data from the hand-piece 108 is communicated to the personal computer for use in updating the virtual environment. The data can be communicated either directly to the host computer 110 through a wired or wireless communication link 112, or the hand-piece 108 could communicate to the host via a single interface located in the user interface. In many embodiments, the interface includes circuitry (e.g., a local microprocessor) for receiving the data from the foot pad and the hand-piece 108 and communicating the data to the host computer 110. The interface circuitry may also receive commands from the host computer 110 for updating modes.

FIG. 2 illustrates one embodiment of the user interface shown in FIG. 1. In one embodiment, the user interface 104 can comprise a ground level pad (i.e., a pad that rests on the floor) constructed from a variety of materials such as resilient material that feels comfortable to the feet (e.g., rubber, foam, or the like, or combinations thereof). Referring to FIG. 2, the user interface 104 comprises two sensor regions (e.g., a left sensor region 202 and a right sensor region 204 separated by a central region 206). In one embodiment, pad sensors (e.g., a left pad sensor and a right pad sensor) can be disposed within a respective sensor region. The left and right pad sensors are adapted to be engaged by the user's left and right feet, respectively, when the user is standing with typical forward facing posture on the pad. Accordingly, the left and right pad sensors may generate sensor data corresponding to each respective left and right sensor region. In another embodiment, more than one pad sensor can be disposed within each sensor region to provide more detailed information corresponding to each respective left and right sensor region.

In one embodiment, one or more pad sensors disposed within the left and/or right sensor regions are provided as contact switches adapted to detect a presence of a user's foot or feet (e.g., within one or two respective sensor regions) and indicate if a user is stepping on the respective sensor region or not. Suitable contact switches for some embodiments include “mat switches” and “tape switches” from TapeSwitch Corporation or London Mat Industries. The pad sensors are positioned such that one or more left pad sensors are triggered when the user has his left foot on the pad and one or more right sensors are triggered when the user has his right foot on the pad. When the user has both feet on the pad, one or more left and right pad sensors are triggered.

In another embodiment, one or more pad sensors disposed within the left and/or right sensor regions are provided as pressure sensitive sensors (e.g., strain gauges, pressure sensitive resistors, pressure sensitive capacitive sensors, pressure sensitive inductive sensors, force sensors, or any other sensors adapted to report the amount of force or pressure being exerted across a range of reportable values, or any combination thereof. Suitable force sensors include an FSR (force sensitive resistor) from Interlink electronics that return a range of values indicating the level of force applied and can be manufactured with a large active area suitable for footfalls. Other suitable force sensors include FlexiForce sensors that return a voltage between 0 and 5 volts depending upon force level applied. In such embodiments, one or more left pad sensors may indicate not only whether or not the left foot is engaging the pad, but with how much force it is engaging the pad. Similarly, one or more right pad sensors may indicate not only whether or not the right foot is engaging the pad, but with how much force it is engaging the pad.

The pad sensors generate pad sensor signals when engaged by the user and are connected to interface circuitry adapted to receive the pad sensor signals and report values of the received pad sensor signals to the host computer 110. As used herein, the term “circuitry” refers to any type of executable instructions that can be implemented as, for example, hardware, firmware, and/or software, which are all within the scope of the various teachings described.

In one embodiment, the display 106 is a television screen. In another embodiment, the display 106 comprises a projector adapted to project images onto a wall or screen. In another embodiment, the display 106 comprises a head-mounted display (e.g., a display mounted within glasses or goggles). When wearing such a head mounted display, it is sometimes easy to get disoriented and fall off the user interface. To address this problem, the head-mounted display may be partially transparent. Small light emitting diodes (LEDs) can also be affixed to the four corners of the user interface so that the boundaries are easier to see through the partially transparent display. Such LEDs are also useful when using the foot pad with a traditional display in a darkened room.

In one embodiment, the hand-piece 108 may comprise a hand controller connected to the user-interface 104. Accordingly, the hand-piece 108 may be adapted to be held in one hand of the user who is engaged with the user interface 104 and engaged by the user to provide additional input information to the host computer 110. The hand-piece 108 includes one or more manually manipulatable controls (e.g., buttons, triggers, dials, sliders, wheels, rockers, levers, or the like, or a combination thereof). The hand-piece 108 may further include a hand-piece sensor (e.g., a tilt sensor, an accelerometer, a magnetometer, or the like, or a combination thereof). In one embodiment, the hand-piece sensor may be used such that the pointing direction of the hand piece, or a portion thereof, is used to control avatar direction during foot-controlled gait activities. Data indicative of the state of the manipulatable controls and/or hand-piece 108 sensors (i.e., hand-piece 108 data) is communicated to the host computer 110 by interface circuitry. One or more communication link(s) 112 (e.g., wired or wireless) may be used to communicate hand-piece data from the hand-piece 108 to the host computer 110. Hand-piece data may be communicated to the host computer 110 via the same interface circuitry used to communicate the pad sensor signals to the host computer 110. In one embodiment, however, interface circuitry used to communicate the hand-piece data to the host computer 110 may be different from the interface circuitry used to communicate the pad sensor signals to the host computer 110. In such an embodiment, the interface circuitry associated with the user interface 104 and the interface circuitry associated with the hand piece may be interfaced with each other and/or with the host computer 110 over a Bluetooth network. In one embodiment, the hand piece 108 is connected to the interface circuitry that resides in the user interface 104 via a wired communication link 112.

In one embodiment, the host computer 110 includes control circuitry adapted to control an avatar within a virtual environment based on pad sensor signals received from the user interface 104 and/or hand-piece data received from the hand-piece 108 via the communication links 112. In one embodiment, the host computer 110 also contains graphical simulation circuitry adapted to run a graphical simulation, thereby presenting the virtual environment to the user via the display 106. The host computer 110 can be a single computer or a number of networked computers. In one embodiment, the host computer 110 can comprise a set top box (e.g., a Sony Playstation, a Microsoft Xbox, a personal computer, etc.). In another embodiment, the host computer 110 comprises a handheld gaming system (e.g., a PlayStation Portable, Nintendo Gameboy, etc) or a handheld computer system such as a Palm Pilot PDA. In other embodiments, the host computer 110 is adapted to communicate information over a network (e.g., the Internet) so that multiple users can interact in a shared virtual environment.

In one embodiment, the interface circuitry associated with the user interface 104 and/or the hand-piece 108 is simple state logic. In another embodiment, the interface circuitry associated with the user interface 104 is a local processor adapted to monitor the pad sensors and report the sensor data to the host computer 110 over a communication link. In another embodiment, the local processor of the interface circuitry associated with the user interface 104 is further adapted to process the sensor data prior to reporting the sensor data to the host computer 110. In one embodiment, the communication link is a serial line, a parallel line, or a USB bus. In another embodiment, the communication link is wireless, allowing the pad to be positioned at a distance from the host computer 110 without a wire being strung between. The wireless connection may be infrared or RF. The wireless connection may use a standard-protocol such as Bluetooth.

As mentioned above, the host computer 110 is provided with circuitry adapted to maintain a virtual environment and control an avatar within the virtual environment based on data received from the user interface 104 and the hand-piece 108. The method by which this is accomplished may be referred to as a human computer interface method. Accordingly, the control circuitry presents a control paradigm to the user, enabling the user to control the avatar in a physically realistic and naturally intuitive manner. In one embodiment, the control circuitry may be implemented as software distributed across both the host and a local processor running on the user interface 104. Exemplary processes by which the control circuitry controls the avatar are described in the paragraphs below.

In one embodiment, the control circuitry may be adapted to control a walking and/or running function of the avatar based upon the user walking and/or running in place when he/she is engaged with the user interface 104. For example, the control circuitry may be adapted to control the speed that the avatar walks within a virtual environment based upon the speed with which the user is walking in place when he/she is engaged with the pad. Accordingly, the faster the user walks in place, the faster the avatar walks in the virtual environment. Control of such a walking function of the avatar can be accomplished by, for example, monitoring the sequence of left/right sensor data on the aforementioned pad and controlling the left/right steps of the avatar in accordance with that sensor data. In an embodiment where one or more pad sensors are provided as contact switches, a walking function of the avatar is controlled when the sensor data indicates a staggered sequence of left, right, left, right, left, right. The frequency and/or timing of the left/right sequence controls the speed of the walking avatar. In this manner, a user can walk faster in place and cause the avatar to walk faster in the virtual environment. Alternatively, the user can run in place and cause the avatar to run in the environment. A threshold level may be set at which speed the avatar transitions from a walking posture to a running posture. In another embodiment, a duty cycle is also used in conjunction with the frequency and/or timing of the left/right sequence to control the walking function of the avatar. For example, the amount of time during which a user's left foot is engaged with the left sensor region controls the length of the stride of on the left leg of the avatar (to a maximum stride limited by the size of the avatar). Similarly, the amount of time during which a user's right foot is engaged with the right sensor region controls the length of the stride of on the right leg of the avatar (to a maximum stride limited by the size of the avatar). Using the exemplary control scheme outlined above, walking functions of the avatar can be controlled naturally and intuitively. Moreover, by using the duty cycle in combination with frequency and/or timing allows, the user can impart complex walking gaits such as “limping” of the avatar.

The control circuitry can distinguish walking from running in a number of ways. In one embodiment, the control circuitry can distinguish walking from running because, during walking, the user's left and right feet contact the pad in a staggered sequence but both feet are never in the air at the same time. In other words, both left and right pad sensors of the pad never generate sensor data indicating “no contact” simultaneously. In another embodiment, the control circuitry can distinguish walking from running because, during walking, each walking cycle is characterized by very short periods during-which both feet are in contact with the pad at the same time. In view of the above, the control circuitry may be adapted to control the avatar to walk instead of run when sensor data indicates that the user's left and right feet contact the pad in a staggered sequence but are never in the air at the same time and/or when sensor data indicates that both the user's feet are periodically in contact with the pad at the same time.

In one embodiment, the control circuitry can distinguish running from walking because, during running, the user's left and right feet never contact the pad at the same time. In another embodiment, the control circuitry can distinguish running from walking because, during running, there are brief periods during which both feet are in the air causing both sensors to report “no contact” at the same time. In view of the above, the control circuitry may be adapted to control the avatar to run instead of walk when sensor data indicates that the user's left and right feet do not contact the pad at the same time and/or when sensor data indicates that both the user's feet are periodically simultaneously in the air. Also, the length of time of the “simultaneous no contact” during running can be used in controlling the gait of the avatar—the longer the time, the higher off the ground the user is getting when running or the longer the stride length.

In an embodiment where one or more pad sensors are provided as pressure sensors, sensor data representing the change in force level exerted by the user while running in place on the pad may be used by the control circuitry may indicate how high the user is getting off the pad while running in place and/or the speed with which the user is running place (i.e., the magnitude of the running intensity). The control circuitry may use such sensor data control a running function of the avatar. Therefore it is natural to map sensor data representing a higher force level to either a faster sequence of strides of the running avatar and/or larger strides of the avatar. Assume, for example, that a user is running in place on the pad. As the user exerts more force on the pad as a result of running more vigorously and/or as a result of getting more height off the pad, the control circuitry controls the running function of the avatar such that the avatar takes larger strides within the virtual environment, moving more quickly within the virtual environment.

In one embodiment, the control circuitry may be adapted to control a turning function of the avatar based upon the user engaging the hand-piece 108. Such a turning function may be controlled as the avatar is controlled by the control circuitry to walk/run. For example, the control circuitry may be adapted to control the direction in which the avatar walks/runs based upon the user's engagement with one or more manipulatable controls included within the hand-piece 108. In one embodiment, the user may engage one or more manipulatable controls, each of which is tracked by a manipulatable control sensor included within the hand-piece 108. The manipulatable control sensor may be a digital switch adapted to indicate a plurality of positions, a potentiometer, an optical encoder, a Hall Effect sensor, or any other sensor or combination of sensors that can provide a range of values as the manipulatable control is engaged by the user. In one embodiment, the manipulatable control is adapted to be moved by a user (e.g., to the left and right). When the user moves a manipulatable control such as a left-right dial, left-right slider, left-right wheel, left-right rocker, left-right lever, or the like, to the left, the manipulatable control sensor generates corresponding data that is communicated to the control circuitry and is subsequently processed to turn the avatar left-ward direction (e.g., when walking forward). When the user moves such a manipulatable control to the right, the manipulatable control sensor generates corresponding data that is communicated to the control circuitry and is subsequently processed to turn the avatar right-ward direction (e.g., when walking forward). The amount of that the manipulatable control is moved in either direction ultimately causes the avatar to turn more significantly in that direction. Accordingly, if a user wishes to cause the avatar to run quickly across the virtual environment, bearing right along the way, the user would run in place on the pad, running at the desired speed, while at the same time moving the manipulatable control to the right to a level that achieved a desired rightward bias. While a manipulatable controls adapted to be engaged by a user to affect a turning function of the avatar have been described as being a dial, slider, wheel, rocker, lever, or the like, it will be appreciated that such a manipulatable control could be provided as a tilt switch or accelerometer responsive to left or right tilting of the entire hand-piece 108. Moreover, manipulatable controls such as buttons, triggers, forward-back rocker, forward-back slider, forward-back wheel, or the like, can be engaged by the user to indicate that the avatar is to walk backwards rather than forwards. It will be appreciated that such manipulatable controls could also be provided as a tilt switch or accelerometer responsive to forward or backward tilting of the entire hand-piece 108.

In one embodiment, the avatar may be performing other functions in addition to walking, running, and/or turning. For example, the avatar may be holding a weapon such as a gun or a sword or a piece of sporting equipment like a racquet or a fishing rod. In such an embodiment, the hand-piece 108 may be provided with manipulatable controls such as triggers, hat-switches, wheels, rocker switches, or the like, adapted to be engaged by the user to control such other functions. For example, a trigger can be provided to allow a user controlling an avatar to fire a weapon. In another embodiment, a supplemental hand-piece can be provided that is adapted to be held in the hand of the user that is not already holding a hand-piece 108. Accordingly, the supplemental hand-piece may include one or more manually manipulatable controls (e.g., buttons, triggers, dials, sliders, wheels, rockers, levers, or the like, or a combination thereof) or a hand-piece sensor (e.g., a tilt sensor, an accelerometer, or the like, or a combination thereof) to control such other functions related to the virtual environment. For example, the supplemental hand-piece could include a hat-switch or d-pad adapted to be engaged by a user to facilitate aiming a gun held by the avatar within a virtual environment as well as a trigger for allowing the user to fire the gun.

In one embodiment, the control circuitry may be adapted to control a turning function of the avatar based upon the user engaging the user interface 104. Such a turning function may be controlled in accordance with the relative timing and/or force levels detected by the pad sensors within the left and right sensor regions. For example, greater foot contact duration on the right side as compared to the left side can be detected by the control circuitry and used to impart a leftward bias on the motion of the avatar. Similarly, greater foot contact duration on the left side as compared to the right side can be detected by the control circuitry and used to impart a rightward bias on the motion of the avatar. In other embodiments, differences in left and right foot force levels are used to control the left and right bias while walking or running.

In one embodiment, the control circuitry may be adapted to control the avatar to stand still (e.g., not walk, run, turn, etc.) within the virtual environment based upon the user standing still when he/she is engaged with the user interface 104. For example, the control circuitry may be adapted to control the avatar to stand still within the virtual environment when pad sensors within the left and right sensor regions are engaged by the user (e.g., pressed) simultaneously for longer than a threshold amount of time (e.g., about two to three seconds).

In one embodiment, the control circuitry may be adapted to control the avatar to stand on one foot within the virtual environment based upon the user standing on one foot when he/she is engaged with the user interface 104. For example, the control circuitry may be adapted to control the avatar to stand on one foot within the virtual environment when a pad sensor within one sensor region is engaged by the user (e.g., pressed) for longer than a threshold amount of time (e.g., about three to five seconds).

In one embodiment, the control circuitry may be adapted to control the avatar to jump within the virtual environment based upon the user jumping when he/she is engaged with the user interface 104. For example, the control circuitry may be adapted to control the avatar to jump within the virtual environment when the user jumps on the pad. In one embodiment, the control circuitry may control the avatar to jump upon determining, based on the profile of received sensor data, that both of the user's feet have left the pad at substantially the same time after a profile of the received sensor data indicates that both feet were previously in contact the pad at the same time. A profile associated with a user jumping can be distinguished from profiles associated with a user running or walking because a user's left and right feet leave the pad and contact the pad in a staggered sequence of left-right-left-right during running or walking. Upon detecting determining, based on the profile of received sensor data, that the user has jumped, the control circuitry outputs a control signal causing the avatar to jump.

In an embodiment where one or more pad sensors are provided as contact switches, the control circuitry may be adapted to control the height to which the avatar jumps based on the time interval detected between when both of the user's feet leave the pad and when both of the user's feet return to the pad. For example, if both the user's feet leave the pad and then, 500 milliseconds later, return to the pad, the control circuitry outputs a control signal adapted to cause the avatar to perform a small jump. If, however, both the user's feet leave the pad and then, 3000 milliseconds later, return to the pad, the control circuitry outputs a control signal adapted to cause the avatar to perform a bigger jump.

In an embodiment where one or more pad sensors are provided as force/pressure sensors, the control circuitry may be adapted to control the height to which the avatar jumps based on the magnitude of the force imparted by the user as the user presses against the pad to become airborne. In one embodiment, magnitude of the force imparted by the user may be used in conjunction with the time interval detected between when both of the user's feet leave the pad and when both of the user's feet return to the pad to determine the height and/or lateral distance of the simulated (i.e., virtual) avatar jump.

In one embodiment, the control circuitry may be adapted to control the direction in which the avatar jumps based upon the prior motion of the avatar before the jump. For example, the control circuitry may be adapted to control the avatar to jump straight up and down (e.g., as if jumping rope) if the control circuitry determines that the avatar was standing still prior to the jump. Similarly, the control circuitry may be adapted to control the avatar to jump with a forward trajectory (e.g., as if jumping a hurdle) if the control circuitry determines that the avatar was moving (e.g., walking, running, etc.) forward prior to the jump. Further, the control circuitry may be adapted to control the avatar to jump with a sideways trajectory (e.g., as if catching a football) if the control circuitry determines that the avatar was moving (e.g., walking, running, etc.) sideways prior to the jump.

In another embodiment, the control circuitry may be adapted to control the direction in which the avatar jumps based upon the user engaging the hand-piece 108. For example, and as similarly described above with respect to controlling the walking/running function of the avatar, the control circuitry may be adapted to control the direction in which the avatar jumps based upon the user's engagement with one or more manipulatable controls included within the hand-piece 108. In one embodiment, the manipulatable control is adapted to be moved by a user (e.g., forward, backward, left, and/or right). When the user moves such a manipulatable control, the manipulatable control sensor generates corresponding data that is communicated to the control circuitry and is subsequently processed to cause the avatar to jump in a forward, backward, leftward, and/or rightward direction (e.g., regardless of the prior motion of the user).

In another embodiment, the control circuitry may be adapted to control the height and distance to which the avatar jumps. Such control may be based on, for example, the user engaging the hand-piece 108, a prior direction of motion of the avatar, and/or a prior speed of motion of the avatar. For example, the control circuitry may be adapted to cause the avatar to jump a short distance forward but at a large height when the control circuitry determines that, based upon sensor readings, the user (and thus the avatar) is running at a slow pace prior to the jump and that the jump itself imparted by the user has a long time interval between takeoff and landing. The control circuitry may be adapted to cause the avatar to jump a long distance forward but at a low height when the control circuitry determines that, based upon sensor readings, the user (and thus the avatar) is running at a fast pace prior to the jump and that the jump itself imparted by the user has a long time interval between takeoff and landing. In another embodiment, the force level detected at the time of takeoff may be used by the control circuitry to control the magnitude of the avatar jump and speed of motion of the avatar prior to the jump may be used by the control circuitry to control the ratio of height to distance of the avatar jump. For example, the control circuitry may cause an avatar moving fast prior to jumping to jump a longer distance and lower height than an avatar moving slowly (or a stationary avatar) prior to jumping.

In one embodiment, the control circuitry may be adapted to control how the avatar lands from a jump within the virtual environment based upon how the user lands from a jump when he/she is engaged with the user interface 104. Accordingly, the control circuitry may control the avatar to land from a jump with two feet (e.g., as in the long-jump) upon determining, based on the profile of received sensor data, that both of the user's feet have returned to the pad at substantially the same time after a profile of the received sensor data indicates that both feet were previously not in contact with the pad at the same time. Similarly, the control circuitry may control the avatar to land from a jump with one foot (e.g., as in jumping a hurdle) upon determining, based on the profile of received sensor data, that one of the user's feet has returned to the pad before the other of the user's feet has returned to the pad after a profile of the received sensor data indicates that both feet were previously not in contact with the pad at the same time.

In another embodiment, the control circuitry may be adapted to control how the avatar lands from a jump within the virtual environment based upon the user engaging the hand-piece 108. In yet another embodiment, the control circuitry may be adapted to control how the avatar lands from a jump within the virtual environment by inferring (e.g., via internal logic) how the avatar should land based upon a task being performed within the virtual environment. If, for example, the task being performed within the virtual environment is a long jump, the control circuitry will control the landing of the avatar's jump such that the avatar lands with two feet. If, for example, the task being performed within the virtual environment is a hurdle, the control circuitry will control the landing of the avatar's jump such that the avatar lands with one foot.

In one embodiment, the control circuitry may be adapted to control the avatar to hop within the virtual environment based upon the user hopping when he/she is engaged with the user interface 104. For example, the control circuitry may be adapted to control the avatar to hop within the virtual environment when the user hops on the pad. In one embodiment, the control circuitry may control the avatar to hop upon determining, based on the profile of received sensor data, that one of the user's feet has repeatedly left and returned to the pad while the other of the user's feet has not engaged a corresponding sensor region of the pad.

In an embodiment where one or more pad sensors are provided as contact switches, the control circuitry may be adapted to control the height/distance to which the avatar hops in a manner similar that in which the control circuitry controls the height/distance to the avatar jumps. In this case, however, the time interval is determined with respect to only one of a user's feet instead of both of the user's feet.

In an embodiment where one or more pad sensors are provided as force/pressure sensors, the control circuitry may be adapted to control the height/distance to which the avatar hops in a manner similar that in which the control circuitry controls the height/distance to the avatar jumps. In this case, however, the magnitude of the force imparted by the user is detected with respect to only one of a user's feet instead of both of the user's feet.

Similar to landing from a jump, a user can land from a hop on either one or two feet. By detecting the sequence of foot presses, this can be determined by the control circuitry. Accordingly, when the user is engaged in a game of virtual hopscotch, the user can control the avatar in a sequence of double foot jumps and single foot hops by performing the appropriate sequence of jumps and hops on the pad as detected by the appropriate sensors. In this way, the control circuitry can control the avatar to perform a hopscotch function based upon the detected sequence and timing of double foot jumps and single foot hops.

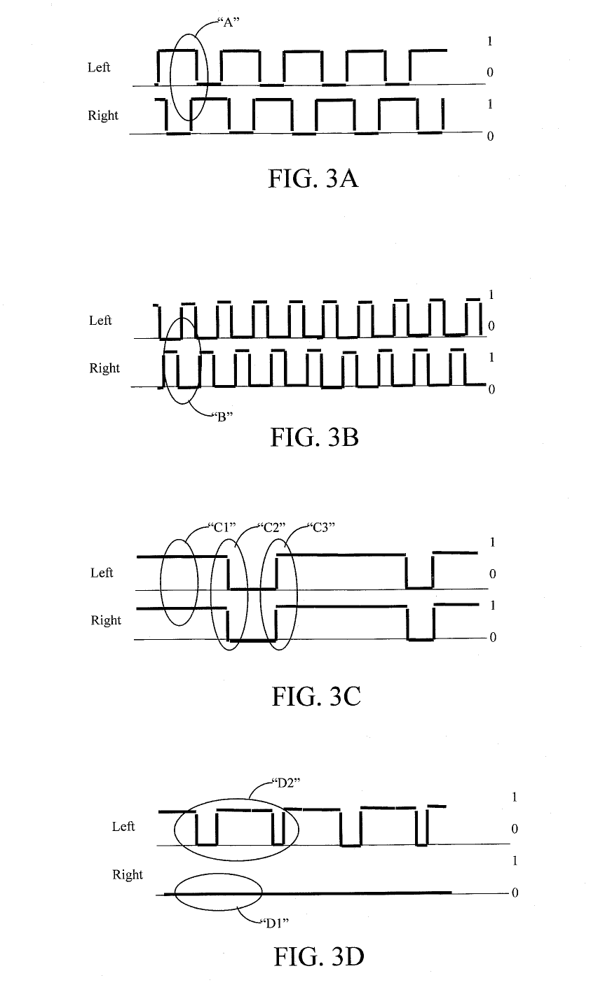

As discussed above, the control circuitry is adapted to control an avatar-based on the aforementioned pad sensor signals. The control circuitry can process pad sensor signals generated by the pad sensors and control the avatar within the virtual environment based on characteristic patterns within the pad sensor signals. FIGS. 3A-3D illustrate exemplary pad sensor signals corresponding to a variety of walking, running, jumping, and hopping activities of the user as described above. In the embodiments exemplarily illustrated in FIGS. 3A-3D, the pad sensor signals are obtained from a pad having left and right sensor regions, each of which including a single contact-type switch as a pad sensor.

FIG. 3A illustrates exemplary pad sensor signals generated by pad sensors as a user performs a walking activity on the pad. As shown in FIG. 3A, when both sensors are simultaneously pressed for short periods during the user's gait, a characteristic pattern emerges where the sensor signals generated by the left and right pad sensors both indicate a high (i.e., a “contact”) state (see area “A”). Further, another characteristic pattern emerges in that there is never a time when sensor signals generated by the left and right pad sensors simultaneously indicate a low (i.e., a “no-contact”) state. Moreover, another characteristic pattern emerges in that a “duty cycle” of the pad sensor signals generated by the left and right pad sensors is greater than 50%, meaning that each of the user's feet spends more time on the ground than in the air.

FIG. 3B illustrates exemplary pad sensor signals generated by pad sensors as a user performs a running activity on the pad. As shown in FIG. 3B, when both sensors are simultaneously not pressed for short periods during the user's, gait, a characteristic pattern emerges where the sensor signals generated by the left and right pad sensors both indicate a low state (see area “B”). Further, another characteristic pattern emerges in that there is never a time when sensor signals generated by left and right pad sensors simultaneously indicate a high state. Moreover, another characteristic pattern emerges in that a duty cycle of the pad sensor signals generated by the left and right pad sensors is less than 50%, meaning that each of the user's feet spends more time in the air than on the ground.

FIG. 3C illustrates exemplary pad sensor signals generated by pad sensors as a user performs a jumping activity on the pad. As shown in FIG. 3C, characteristic patterns emerge when both sensors are simultaneously pressed for an extended period (see area “C1”) and then a force is removed from both sensors simultaneously (see area “C2”) and then both sensors are simultaneously pressed (see area “C3”).

FIG. 3D illustrates exemplary pad sensor signals generated by pad sensors as a user performs a hopping activity on the pad. As shown in FIG. 3D, a characteristic pattern emerges when one sensor shows no contact for an extended period (see area “D1”) while the other pad sensor shows repeated contact/no contact (see, e.g., area “D2”). In one embodiment, the control circuitry may be adapted to use the duration of the no-contact as a measure of the vigor of the hopping.

As described above, common foot-based activities such as walking, running, jumping, and hopping can be identified, quantified, and/or distinguished from each other based upon the characteristic patterns that are contained within the profile of the sensor signals produced by the pad sensors as the user performs the physical activity. In addition to identifying which activity is being performed (walking, running, jumping, hopping, etc.), analysis of the sensor data profile can determine the speed at which a user is walking or running and/or the magnitude at which the user jumps. The speed of walking and/or running is determined based upon the time elapsed between sensed footfalls and/or based upon the force intensity of the footfalls (for embodiments that use force sensors) and/or based upon the frequency of footfalls over a certain period of time. A certain slow range of measured running speeds (and/or low force-range of magnitude of footfall forces) may be determined in software to be “jogging” while a faster range of measured running speeds (and/or a high force-range of magnitude of footfalls) may be determined in software to be “running”.

As described above, the digital pad sensor signals exemplarily illustrated in FIGS. 3A-3D are generated by digital pad sensors arranged within a pad having left and right sensor regions, each of which include a single contact-type switch as a pad sensor. However, when one or more sensor regions includes one or more pad sensors provided as force/pressure sensors, the time varying characteristics would look different (e.g., the time varying characteristics would vary between the minimum and maximum values shown). In such embodiments, profiles of the time varying characteristics, similar to the profiles illustrated in FIGS. 3A-3D may be extracted by simple software analysis (e.g., by looking at the change in the magnitude over time and/or by filtering the data in hardware or software based upon exceeding maximum and minimum threshold levels). In one example, a Schmitt Trigger or other signal conditioning hardware or software may be used to extract signal profiles similar to those shown in FIGS. 3A-3D, even when analog sensors are used. The advantage of analog sensors is that additional information is provided, not just about contact/no-contact but the magnitude of the contact. Accordingly, instead of the number “1” indicating the high state in FIGS. 3A-3D, the pad sensor signals are analog signals that would return a value in a range (e.g., from 0 to 16 or from 0 to 256) indicating a user's engagement with the user interface.

When using analog sensors, signal noise can be a problem. Filters are often used to clean the signal. One significant problem with noise is the result of a false indication of “no-contact”. Therefore a range of very small values are usually used to indicate n-contact. For example, if the force sensor provided data 0 to 256 to indicate the magnitude of the foot pressure on the pad, the range 0 to 16 may be used to indicate no-contact. This range would be chosen below the range of functional foot forces.

From aerobics to basketball, a pivot (which is shifting the majority of one's weight from one side of the body to the other) can be detected by the embodiments that include force sensors. As defined herein, a pivot is a user physical activity wherein he or she shifts the majority of his weight in one direction—either shifting the majority of his or her weight to the left foot, or shifting the majority of his or her weight to the right foot. This can be detected by embodiments of the present invention which include at least a plurality of analog force sensors,.one on the left side of the footpad and one on the right side of the footpad. A pivot can be detected as a dynamic activity wherein force is detected on both left and right force sensors with a generally even distribution (or within some threshold of an even distribution). This is followed by a changing sensor distribution such that substantially more force (i.e. a force above some absolute or relative threshold) is detected on the force sensor on one side, while some minimum amount of force is still detected upon the other side (thereby indicating that both feet are still in contact with the footpad). If the force is detected to be higher on the right side than the left side, the user is determined to be pivoting right and the avatar is controlled accordingly in software. If the force is detected to be higher on the left side than on the right side, the user is determined to be pivoting left and the avatar is controlled accordingly in the software. The magnitude of the pivot can also be determined by the magnitude of the difference between the left and right force sensor readings and/or by the time duration that the difference lasts. The magnitude of the pivot may also be used to control the avatar accordingly.

In one embodiment, it may be desirable for the user to control the direction of walking and running and jumping, not by using a hand control, but entirely by foot motion on the pad. Such an embodiment may use force sensors and look at the shifting weight of the user to control direction. If the user is shifting more weight towards the right, the avatar will bias towards the right. If the user is shifting more weight backwards, the avatar will walk backwards. Such embodiments require a differential force sensor on each side of the pad, the differential force sensor providing readings for both the front and back portions of each side of the pad. In a further embodiment, the differential force sensor would not just detect downward force on the pad, but also tangential force on the pad. In such an embodiment, the direction of the tangential force can be used to control direction.

As described previously, interface circuitry associated with the user interface 104 is used to read the various sensor values and report sensor values to the host. The interface electronic may also be capable of receiving signals from the host, to set communication parameters or other modes/states of the user interface. In one embodiment, the interface circuitry reports raw sensor data to the host computer. In other embodiments, the interface circuitry includes firmware running on a local processor that formats the pad sensor signals and streams it over a communication protocol. In some cases, the interface circuitry may process the pad sensor signals and identify the user activity—walking, running, jumping, hopping, etc. In some embodiments, the interface circuitry determines the motion, for example “walking at 50% speed forward” and then send an emulation signal to the host, “joystick forward at 50%” because that signal would achieve the desired motion of the avatar. In one embodiment, the host performs the determination and control of the avatar based on sensor data directly. Such an embodiment provides for more general and more sophisticated control of avatar physicality.

According to numerous embodiments described herein, the host computer contains circuitry adapted to enables avatar motion within a virtual environment, thereby allowing a user to walk, run, jump, and otherwise interact within a three dimensional virtual environment. In one embodiment, users may engage with the user interface at home and connect to a multi-user virtual environment over the Internet. In another embodiment, host computer enables the user to move (e.g., walk) within the virtual environment and interact with other users by voice chat, text chat, and other methods known to those skilled in the art. Enabling multiple users to interface with the shared environment, the users controlling their avatars by physically interacting with their respective user interfaces, creates an opportunity for simulated (i.e., virtual) sporting and simulated fitness activities among individuals and groups of individuals. In one embodiment, the host computer allows users to participate in such activities while achieving physical exercise, making the experience more than just a computer experience, but a fitness experience.

For example, the virtual environment could provide a jogging trail to users. The jogging trail could be a realistic length, for example ten miles. In order for the user to cause his or her avatar to jog along the ten mile jogging trail, the user would need to jog in place with an exertion similar to jogging ten miles. The speed of jogging and the direction of jogging would be controlled as described above. In addition, the user can be jogging along side other users of this environment, jogging as a group and socializing by talking as would be done in the real world. As a result, this networked hardware/software solution provides a means of achieving exercise while enabling human to human communication in a social environment.

In some embodiments, the virtual environment is configured to organize a race within the environment wherein multiple users compete against each other as they would in a real world race. The elapsed time and distance covered is provided to the user on the screen that is displaying the virtual environment, giving the user additional information about the fitness experience achieved. In some embodiments additional data such as estimated calories burned is tracked and displayed based upon the leg motion of the user. In addition, the virtual environment is configured in some embodiments to track user ability over time. For example, a given user could jog the same ten-mile jogging trail every day. The host computer logs data about performance each day so that the user could see his/her performance changes over time. An important aspect of the present invention is the versatility—a user can navigate throughout the graphical world at will, staying on the trail or leaving the trail. This can be achieved using the steering methods in the hand-piece 108 as described previously. In addition, the user can engage in other activities within the virtual environment beyond just jogging. Additional examples will follow in the paragraphs below.

In one exemplary implementation, the virtual environment presents a course of hurdles wherein a user must run and jump to clear the simulated (i.e., virtual) hurdles. The host computer can track if the user successfully cleared the hurdle by performing collision detection between the avatar and the simulated hurdles. By requiring the user to run and jump, this solution provides a more vigorous and more challenging exercise regimen. Because this is a virtual environment, the hurdles could be more abstract—for example, simulated boulders could be rolling towards the user and the user must jump over. Or there could be floating rings in the environment that the user must jump through. There are a variety of ways to provide an interesting, challenging environment for exercise benefit.

In another exemplary implementation, a simulated long jump pit is provided within the virtual environment, allowing a user to control his avatar to run down the strip and jump into the pit. The software tracks the length of the simulated (i.e., virtual) jump. The host computer also tracks if the user had a “foot fault” when executing the jump. This implementation allows users to practice the long-jump for fun or to compete with other users within the environment. In this example, the host software determines the length of the jump as a result of the speed of the avatar motion when running up to the jump point as well as the duration of the jump executed by the user on the pad. When force sensors are used in the pad, the force of the jump would also be used in determining the length of the jump. Using the “hop” detecting feature, the “Triple Jump” event could also be enabled within the environment.

In another exemplary implementation, a simulated high-jump event is provided within the virtual environment, allowing a user to control his avatar to run down the strip and jump over the bar. The host computer tracks if the user cleared the bar, based upon the speed of running, the height of the jump, and the timing of any required hand controls. The host computer progressively increases the height of the bar. The host computer enables multiple people to compete against each other in a round robin tournament manner.

In another exemplary implementation, a simulated pole vault is provided within the virtual environment. A user can run within the pole by running on the pad as described above. The user could put down the pole, using the finger controls on the hand-piece 108. The host computer tracks if the user cleared the bar, based upon the speed of running, the height of the jump, and the timing of any required hand controls. The host computer progressively increases the height of the bar. The host computer enables multiple people to compete against each other in a round robin tournament manner.

In another exemplary implementation, a “squat” exercise regimen is enabled within the virtual environment by controlling the avatar to perform squats. This may be performed within a setting that resembles a simulated gym. As like a real gym setting, the virtual environment can provide a simulated mirror so that the user can see themselves (i.e. see their avatar from the perspective of the mirror) when performing squats or other leg exercises. To enable the squat feature, a version of the pad is required that has the force sensor capability. The squat motion can be inferred by circuitry contained within the host computer analyzing the profile of left and right force sensor readings, detecting that the force level never drops below the threshold that indicates “no-contact” thereby determining that the user is not jumping, while at the same time detecting the left and right force sensors cycle together up and down, indicating that the user is accelerating his or her torso up and down in a squat-like manner.

In another exemplary implementation, a user may engage in a simulated jump-rope exercise within the virtual environment (e.g., the avatar would be seen doing the jump rope as the user jumped on the pad). The motion of the rope may be controlled automatically by the computer, or the user may control the speed of the rope using the controls provided by the hand-piece 108. The host computer may also track user performance in terms of the number of jumps, whether or not the rope was hit and got tangled on the users legs, as well as whether the height of the jumping was sufficient to clear the rope. In addition, a multi-user environment is provided in some embodiments for jump rope where other networked users are controlling the rope (e.g., the speed and or height of the rope motion) while a different user is jumping. Finally, the multi-user environment is provided in some embodiments to enable multiple users to jump on the same rope, simulating the double-Dutch style of jumping. Again, the benefit of this invention is that it both provides a physically interesting form of exercise within a virtual environment while also providing a social context for person to person communication—the multiple users who are engaging in the jump-rope exercise could be chatting in real time as a group while performing from remote locations.

In another exemplary implementation similar to the jump rope implementation, a virtual environment is provided that includes a hopscotch grid drawn on the ground. The user controls his/her avatar using the methods described herein and executes the hopscotch activity. This may be performed with multiple users networked over the Internet for a social benefit.

In another exemplary implementation, the popular children's game of tag (as in “tag, you're it”) can be played within the simulated multi-user environment using the hardware/software combination disclosed herein. The hand-piece 108 is used to control the “tagging” function while the running is controlled using the foot pad interface.

In another exemplary implementation, the popular children's game of hide-and-seek may be played within the virtual environment using the disclosed hardware/software combination.

In another exemplary implementation, the avatar may participate in a sport that requires catching and tossing a projectile such as a ball or a Frisbee. The foot pad interface allows the user to control the motion of the avatar, running and jumping as appropriate. The hand-piece 108 enables the hand motions.

In another exemplary implementation, multiple avatars may be controlled follow the methodology above for projectile sports, allowing users to engage in team sporting activities such as soccer, basketball, tether-jump, volley ball, and the like.

When implementing the ambulatory based human computer interface so as to allow users to engage in soccer, a user's running, jumping, and kicking can be tracked by the foot pad peripheral device, allowing users to control their avatars and play the game. Other functions, like heading the ball, is controlled either automatically when the software detects an appropriate situation, or by using the hand-piece 108 controls. Kicking can be performed by using a trigger on the hand-piece 108 along or in combination with foot pad interaction.

When implementing the ambulatory based human computer interface so as to allow users to engage in basketball, each user controls a basketball avatar through the combined motions of their feet on a foot pad and manipulations of the hand-piece 108. For example, a player can walk, run, and jump, as described previously, on the pad and control the basketball player avatar appropriately. Pivoting left and right can also be achieved by monitoring user foot motion on the pad. In the basketball software scenario, additional features are enabled. For example, by controlling the hand-piece 108, a user can dribble the ball while walking, running, and pivoting. The dribbling function can be achieved by holding a dribble button or by repeatedly manipulating a dribbling control with each bounce of the ball. An accelerometer in the hand-piece 108 may monitor a dribbling hand-motion of the user, controlling the speed and strength of the dribble motion and controlling the avatar accordingly. In addition, combinations of foot motions on the pad and hand manipulations of the hand-piece 108 can be used to control avatar motions such as jump-shots, lay-ups, fade away shots, jumping blocks, and reach-in steals. For example, the foot-pad and host software can detect a two-footed jump as described previously. Such a jump, executed when the avatar is in possession of the ball is determined by the host soft algorithms to either be a shot or a pass. When the user is still in the air, as determined by the foot pad sensors, the user presses a button on the hand-piece 108. The shoot button will cause the avatar to complete the execution of the jump-shot. The pass button will cause the avatar to pass the ball. If the user's feet land on the pad before the button is pressed, the shot or pass was not successfully executed and “traveling” is called on the user. Similarly, if the user is running on the pad, and the avatar is approaching the basket in the simulated world, the user can make the avatar execute a lay-up. The user must leave the ground from the appropriate foot and press the hand-control at the appropriate time, to successfully execute the lay-up. As a result, the present invention requires physical exercise as well as presents a demanding requirement on the user for coordination and timing of whole body motions, similar to the real sport. If the avatar does not have possession of the ball when the jump is detected by the host as a result of the sensors on the pad, the avatar executes a “block” with hands raised above the head. Other jumping scenarios are enabled, such as a “tip-off” when the avatar jumps and presses the hand-piece 108 at the right time to try to tip the ball. In embodiments that include force sensors within the pad, the height of the jumping of the basketball avatar are controlled by the readings on the force sensors.

Similar jumping and blocking and tipping techniques are used for other sports such as simulated volley ball. In volley ball the hand-piece 108 allows the user to choose between a dig, a tap, a block, etc.

When implementing the ambulatory based human computer interface so as to allow users to engage in “tether jump” (i.e., a tether ball is spun around and around on the ground in a circle). Typically, kids playing tether jump are arranged around the circle and must jump over the ball when it gets to them. This causes an interesting visual effect for the kids are jumping over the ball in a cyclic wave that goes round and round the circle. If someone does not jump on time, or does not jump high enough, they are hit with the ball, and eliminated. The last one standing, wins. Multiple users can be networked simultaneously to the virtual environment and participate in the event. Other users are networked within the virtual environment and just watch the event taking place. The ball is spun on the rope automatically by software. The software keeps track of who has been eliminated by performing collision detection to assess if a user has appropriately cleared the ball, by jumping at the right time and to a sufficient height. Again, this hardware software solution is designed to provide an exercise experience within a social environment wherein multiple users can be communicating at the same time.

The resulting speed that the avatar walks or runs within the virtual environment can be influenced by factors other than just how quickly the user is stepping on the pad. For example, if the avatar is walking up hill or walking up stares, the mapping between user foot steps and avatar speed can be slowed so that the user has to walk faster to get the avatar to achieve the desired speed. This effect causes the user to exert more effort when the avatar is going up hill or up stairs. Similarly, the mapping may be reverse when going down hill or down stairs. In such a case, the user would have to walk slower than normal when going down stairs to maintain a desired speed. This effect causes the user to feel like he/she is being pulled by the force of gravity.

There are some instances in which a user may want to control an avatar walking up stairs or up a hill and experience physical exertion that reflects a climbing experience. Accordingly, a step-up foot pad interface, similar to the user interface 104 shown in FIGS. 1 and 2, may be provided. The step-up foot pad interface has two levels of pads—a ground level pad that rests on the floor and a step-up level pad that is one step higher than the ground level pad. In one embodiment, both the ground level and step-up level pads include left and right sensor regions, wherein each sensor region includes one or more pad sensors as described above. Using the step-up foot pad interface, the user 102 can step back and forth between the ground level and the step-up level, triggering the left and right sensors on each level. Control circuitry tracks the sequence of level changes as well as the sequence of left and right footfalls. Using the pad sensor signals described above, the control circuitry determines if a user is ascending or descending simulated stairs and controls the avatar accordingly.

As is evident, numerous embodiments disclosed herein beneficially provide a user with a more natural means of controlling an avatar within a virtual environment and provide a user with a means for engaging in fitness and/or sporting activities within a virtual environment. Some exemplary fitness-related activities are described in the paragraphs below.

In one exemplary implementation, the user interface disclosed herein could also be used by one or more users for controlling avatars in performing aerobics. For embodiments that have multiple users performing aerobics together, each interfaced over the internet to a shared simulation environment, music would ideally be provided to the multiple users simultaneously over the Internet preferably by a broadband Internet link. In response to that music, the users would control their avatars, ideally synchronized with the rhythm. Leg motion in the aerobics can be controlled just like walking, hopping, pivoting and running, described above using a combination of foot placement and manipulation of the hand-piece 108. The host computer 110 could also keep track or the level of exercise, including duration of workout, repetitions of given motions, as well as vigor. For example, if the host computer 110 detects that the aerobic exercise is becoming less vigorous because the leg motions are slowing, the host can have a simulated avatar provide verbal encouragement. As like a real gym setting, the virtual environment can provide a simulated mirror so that the user can see themselves (i.e., see their avatar from the perspective of the mirror) when performing. Also, as mentioned previously, a specialized hardware interface called a step-up pad interface can be used to control an aerobic avatar performing stepping exercise routines. The value of stair stepping exercise routines is the added exertion required to lift the body up and down the single step provided.

In another exemplary implementation, the ambulatory based human computer interface enables simulated hikes and nature walks within a virtual environment. As described previously, the incline of the terrain can be used to alter the mapping between user walking speed and avatar walking speed, thereby simulating the additional effort required to walk up hill, and the reduced effort required to walk down hill.

Although most of the disclosed simulated (i.e., virtual) activities described above assume an avatar walking, running, jumping, and otherwise performing within a virtual environment with earth-like physics. In other embodiments, however, alternate or modified physics may be used with the disclosed human computer interface. For example, a user may be controlling an avatar that is walking on the moon wherein gravity is substantially reduced. In such a scenario, the typical walking gait becomes slower, with longer strides, with both feet potentially leaving the ground at once. Similarly, increased gravity, magnetic fields, strong winds, and other virtual environmental forces can influence the control of an avatar. For example, walking into a strong wind can be simulated by changing the mapping between user steps and avatar steps so that more exertion is required on part of the user to impart the same level of forward motion of the avatar had there been no wind. Or walking with a strong wind to the back, the inverse mapping can be executed, simulated assistance to walking. Similarly, a user that is controlling an avatar that is carrying a heavy load could have similar impairments upon walking speed, jumping height, etc., forcing the user to exert more effort to achieve the same simulated effect.

There may be some scenarios within the virtual environment wherein the avatar must be controlled to walk over a narrow surface such as a fallen log, a narrow bridge, a balance beam, a tightrope, etc. In such scenarios, the user could be required by software to use only one of the two sensors (left/right sensor) when walking on the pad to make the avatar proceed. For example, the user might have to walk only with the left sensor, moving his feet awkwardly on the pad to walk with both feet on a single narrow sensor. This simulates the difficulty required of the avatar walking over the narrow area.

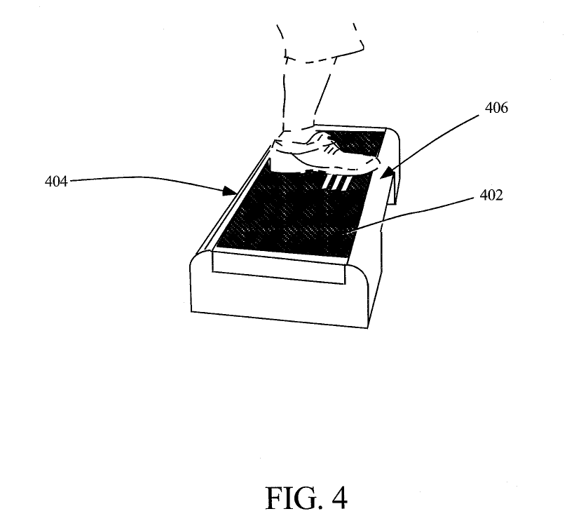

In many embodiments, the user interface 104 described above with respect to FIGS. 1 and 2 is somewhat flexible. It will be appreciated, however, that the user interface 104 may be provided as a rigid stepping platform that rests upon supports that include in-line sensors. As shown in FIG. 4, for example, a user interface 104 may include a rigid stepping platform 402 mounted upon a left support leg 404 and a right support leg 406. Although not shown, at least one force sensor is integrated into each of the left and right support legs to measure the downward force upon each of the left and right support legs resulting from the user standing, walking, running, jumping, hopping, or otherwise interacting upon the platform above. The sensors are configured such that the user's downward force is measured by the left and right sensors, the left-right distribution of force being detected by the relative reading of the left and right in-line sensors. When the left and right sensors read equal (or nearly equal) force readings, the user has both feet upon the footpad. When the left sensor readings are significantly greater than the right sensor readings (or when the left sensor readings exceed the right sensor readings by more than a pre-defined relative or absolute threshold), then the user likely has his or her left foot in contact and right foot in the air. When the right sensor readings are significantly greater than the left sensor readings (or when the left sensor readings exceed the right sensor readings by more than a pre-defined relative or absolute threshold), then the user likely has his or her right foot in contact and left foot in the air. When both sensors read zero force (or when both sensors read force values below some lower threshold), the user likely has both feet in the air. By monitoring the sensor signals and determining which feet are in contact, the sequence of the contacts, and timing of the contacts, the software can determine if the user is walking, jogging, running, jumping, hopping, or pivoting, as described throughout this document.

In one embodiment, the rigid stepping platform includes a local microprocessor containing circuitry adapted to read sensor signals generated by the left and right sensors and send the sensor signals (or a representation of the sensor signals) to the host computer 110 via communication link 112 (e.g., a wireless communication link such as a Bluetooth wireless communication connection). In one embodiment, the rigid stepping platform is battery powered to eliminate the need for power wires to the platform. Such a platform looks very much like a standard stepping platform used in aerobics except that it include sensors hidden in (or affixed to) the support legs and includes internal electronics and batteries. The device also includes an on/off switch and one or more status LEDs. Configuration and control of the sensors and circuitry within the rigid user interface occurs through the wireless connection with the host computer 110. In some embodiments a wired connection can be used such as a USB connection to the host computer 110. In such embodiments power can be supplied to the control electronics over the USB connection and/or from an external power plug.

In many embodiments, the user interface 104 described above with respect to FIGS. 1, 2, and 4 is provided as a pad of some sort. It win be appreciated, however, that the user interface 104 can be provided as one or more sensors incorporated into, or otherwise affixed to shoes worn by the user. While the majority of this disclosure focuses upon the foot pad style interface, the methods employed for the shoe style interface are similar. In the shoe style interface, the left shoe has a sensor (either integrated therein or affixed thereto) that acts similarly to the pad sensor in the left sensor region 202 of the pad and the right shoe has a sensor (either integrated therein or affixed thereto) that functions similarly to the pad sensor in the right sensor region 204 of the pad. In one embodiment, each shoe incorporates control electronics containing circuitry adapted to read the sensors and communicate sensor readings to the host computer 110. In many embodiments, the control electronics includes a local microprocessor within each of the left and right shoes, the local processors polling the sensors to detect the physical activity of the wearer and report data indicative of the sensor readings to the host computer 110. Such data transmission can occur through a wire connection or wireless link. In many embodiments the data transmission occurs through a wireless Bluetooth connection, the left shoe and right shoe and host computer 110 connected to the same Bluetooth network.

In one embodiment, a user of the shoe-style interface described above may use the aforementioned hand-piece 108 to control, for example, the direction in which the avatar walks, jogs, runs, jumps, hops, etc., within the virtual environment. Alternatively, a spatial orientation sensor may be integrated into the shoe and/or affixed to the shoe. For example, a magnetometer may be incorporated within at least one of the shoes to provide spatial orientation information with respect to magnetic north. The spatial orientation information from the magnetometer may be used to control the direction of walking of the avatar within the simulated environment. In some embodiments, the absolute orientation provided by the shoe magnetometer is used to control the orientation of the avatar within the simulated environment. In other embodiments, the change in orientation provided by the shoe magnetometer is used to control the change in orientation of the avatar within the simulated environment.

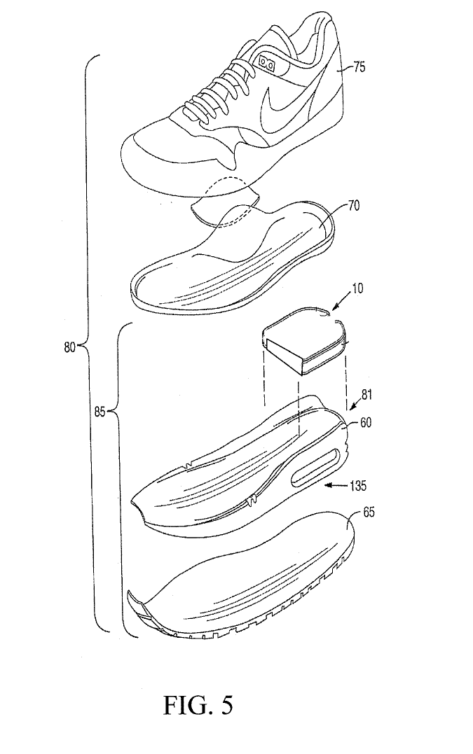

There are numerous methods by which force sensors can be incorporated into shoes (or otherwise affixed thereto) for collecting data that can be processed consistent with the methods and apparatus of this invention. For example, pressure sensors can be incorporated into fluid filled bladders within the shoes, the pressure sensors detecting the force level applied by the user on one or more portions of the shoe. An example of such a system is disclosed in Provisional U.S. Patent Application 60/678,548, filed on May 6, 2005, which is hereby incorporated by reference in its entirety. Another method is to embed strain gauges, piezoelectric sensors, electro-active polymer sensors, pressure sensors, force sensitive resistors, and/or other force or pressure sensitive transducers into the underside of the shoe. FIG. 5 shows one exemplary configuration of such a sensored shoe configuration.

An article of athletic footwear 80 including a switch or force sensor for electronically detecting the contact and/or magnitude of contact between the shoe and the ground when worn by a user is shown in FIG. 5. Although only one article of footwear is illustrated, it will be appreciated that the embodiments discussed herein may be readily implemented in conjunction with a pair of articles of footwear 80. The embodiment drawn includes a sensor system 10 according to the present invention. The sensor system 10 can be an on/off switch that is activated if the user applies downward pressure with his or her foot. The sensor system 10 can be a force sensor and/or a pressure sensor that reports a level of downward force applied by the user when wearing the shoe. Footwear 80 is comprised of a shoe upper 75 for covering a wearer's foot and a sole assembly 85. Sensor system 10 is incorporated into a midsole layer 60. An outsole layer 65, for engaging the ground, is secured to at least a portion of midsole layer 60 to form sole assembly 85. A sock liner 70 is preferably placed in shoe upper 75. Depending upon the midsole material and performance demands of the shoe, midsole layer 60 can also form part of or the entire ground engaging surface so that part or all of outsole layer 65 can be omitted. Sensor system 10 is located in the heel region 81 of footwear 80 and is incorporated therein by any conventional technique such as foam encapsulation or placement in a cut-out portion of a foam midsole. A suitable foam encapsulation technique is disclosed in U.S. Pat. No. 4,219,945 to Rudy, hereby incorporated by reference.

Although the sensor region is shown in the heel region of the shoe in FIG. 5, the sensor can extend from the heel region to the toe region. Alternately multiple sensors can be used, including one in the heel and one in the toe of each shoe. The one or more sensors are wired (wires not shown) to the control electronics (not shown), the control electronics communicating with the host computer 110 by wireless transmission.

The sensor signals detected by the sensor integrated within or affixed to the shoes are processed using the same techniques mentioned previously for the foot pad interface described throughout this disclosure to determine if the user is walking; jogging, running, hopping, jumping, or pivoting. The sequence and profile of the sensor signals can similarly be processed to determine the speed of the walking, jogging, or running as well as determine the magnitude of the jumping, hopping, or pivoting. The determinations can furthermore be used to control the motion of one or more avatars within a virtual environment as disclosed throughout this document.

One advantage of the sensored shoe style interface as compared to the foot pad interface disclosed previously in this document is that the user of the shoe style interface need not walk in place, jog in place, run in place, jump in place, hop in place, or pivot in place, but instead can walk, run, jog, jump, hop, and/or pivot with a natural forward motion and/or other directional motions. In this way, a user of such a system can be more mobile. It is for this reason that a handheld computer system rather than a stationary computer system is often the preferred embodiment for systems that employ the shoe style interface. Additional detail is provided on the handheld computer system embodiments below.

As mentioned previously, the host computer 110 may be provided as a handheld gaming system such as a Playstation Portable or a handheld computer system such as a Palm Pilot PDA. Because such systems often integrate manual controls (such as buttons, sliders, touch pads, touch screen, tilt switches, and the like) into a single portable handheld hardware unit, such a portable handheld hardware can further function both as the display 106 and as the hand-piece 108 enabling manual input. Also such hardware can function as a music player, providing music to the user for workout activities. In one handheld computing embodiment, a Bluetooth wireless communication connection is established between the handheld computing device and the processor within the footpad interface.

In one embodiment enabled the current invention the user is walking, jogging, or running in place upon the foot pad interface (or using the sensored shoe interface as described above), controlling an avatar within a gaming/exercise software activity. The software uses an internal clock or timer within the host computer 110 to keep track of the elapsed time taken by the user as he or she navigates a certain course. In some embodiments a score is generated by the software based in whole or in part upon the elapsed time. In one embodiment of the this game, objects are graphically drawn as rapidly approaching the avatar controlled by the user, the objects being for example “barrels” or “boulders”. The user must jump on the footpad (or wearing the sensored shoe) at a properly timed instant to cause his or her avatar to jump over the barrels and continue to successfully play the game. The jumping activity causes substantial exertion on the part of the user, thus the software can increase the difficultly of the workout experience by increasing the frequency of the approaching barrels or boulders. In addition the software can monitor the time during which both of the user's feet are in the air during a jump (as mentioned previously) to determine the magnitude of the user's jump. Using this magnitude, some embodiments of the software can determine based upon the size of the jump if the user sufficiently clears the approaching obstacle (such as the bolder or barrel). Boulders, barrels, and/or other obstacles can be modeled and drawn at various sizes by the software program and thereby require the user to jump with varying levels of exertion to clear them. In this way the software can vary not just the frequency of obstacles that must be jumped over to vary the exertion level required of the player, but the software can also vary the size of the obstacles to vary the exertion level required of the player. In one embodiment, the software varies the timing, the frequency, and the size of the approaching obstacles that must be jumped over by the user as a way to vary the intensity of the workout as well as vary the skill-based challenge level of the gaming activity. While the embodiment described above uses barrels and/or boulders that the user must jump over, other obstacles can be used in the simulation-activity, including but not limited to holes or gaps in the ground that must be jumped over, simulated streams or rivers that must be jumped over, hurdles that must be jumped over, or pits of fire that must be jumped over. While the embodiments described above requires a user to control the avatar to jump over graphical obstacles, other embodiments require the user to control the avatar to jump up and grab hanging, dangling, floating, or flying objects. In such embodiments the gaming software computes a score based upon the number of successful obstacles jumped over (or jumped up to) and/or based upon the elapsed time taken by the user to complete a proscribed course or level. In this way, the user gets an exercise workout but is also motivated to achieve a high gaming score and develop the skills required to do so. In addition to a score, the gaming software in some embodiments also computes and presents an estimated number of calories burned based upon the number of footfalls and/or the magnitude of the footfalls and/or the elapsed time and/or the frequency of footfalls during the gaming experience.

Another sample gaming embodiment has obstacles approach the user that are too large to be jumped over (or otherwise not intended to be jumped over)—instead the user must use the pivot function as described previously to avoid the obstacles. An obstacle that approaches slightly to the right of the user is avoided by the user pivoting left and thereby causing his avatar to pivot left and avoid the obstacle. An obstacle that approaches slightly to the left of the user is avoided by the user pivoting right and thereby causing his avatar to pivot right and avoid the obstacle. In such embodiments the gaming software computes a score based upon the number of successful obstacles avoided and/or based upon the elapsed time taken by the user to complete a proscribed course or level. In this way, the user gets an exercise workout but is also motivated by achieve a high gaming score and develop the skills required to do so. In addition to a score, the gaming software in some embodiments also computes and presents an estimated number of calories burned based upon the number of footfalls and/or the magnitude of the footfalls and/or the elapsed time and/or the frequency of footfalls during the gaming experience.

It will be appreciated that embodiments described herein can support both third person avatar control and first person avatar control and can be used with hardware and software systems that allow users to freely switch between first and third person modes. A third person mode is one in which the user can view a graphical depiction of the avatar (i.e., a third-person view of the avatar) he or she is controlling, as the user walks, runs, or otherwise controls the avatar, he or she can view the resulting graphical action. A first person mode is one which the user can view (i.e., via a first-person view) the virtual environment from the vantage point of the avatar itself (for example through the eyes of the avatar). In such embodiments the user may not see the avatar move but experiences the effects of such motion—as the avatar walks, runs, jogs, jumps, or otherwise moves within the environment, the user's view of the environment changes accordingly.

For example, alternate types of sensor, alternate or additional host software activity scenarios, alternate electronics and software structures, can be used in other embodiments. Furthermore certain terminology has been used for the purposes of descriptive clarity, and not to limit the present invention. It is therefore intended that the following claims include all such alterations, permutations, and equivalents as fall within the true spirit and scope of the present invention.

Exemplary benefits obtained by implementing the various embodiments described above include the creation of a more immersive, realistic, and engaging computer entertainment/computer gaming experience for the user, and providing a physically intensive computer experience that requires the user to get genuine physical exercise by controlling an avatar.

While embodiments disclosed herein have been described by means of specific examples and applications thereof, numerous modifications and variations could be made thereto by those skilled in the art without departing from the scope of the invention set forth in the claims.

What is claimed is:

1. A human computer interface system, comprising:
a user interface comprising a plurality of sensors, the sensors adapted to detect footfalls of a user's feet and generate corresponding sensor signals;
a host computer communicatively coupled to the user interface, the host computer adapted to manage a virtual environment containing an avatar associated with a user; and
control circuitry adapted to:
identify, from the sensor signals, a physical activity being currently performed by the user from among a plurality of physical activities based at least in part upon at least one of a sequence and a timing of detected footfalls of the user, the plurality of physical activities including at least two of standing, walking, jumping, hopping, jogging, and running; and
control the avatar within the virtual environment to perform one of a plurality of virtual activities based at least in part upon the identified physical activity of the user, the plurality of virtual activities including at least two of standing, walking, jumping, hopping, jogging, and running, wherein
the host computer is further adapted to drive a display to present a view to the user of the avatar performing the virtual activity within the virtual environment.

2. The interface system of claim 1, wherein the control circuitry is adapted to control a speed at which the avatar performs at least one virtual activity of walking, jogging, and running based at least in part upon the rate of detected footfalls of the user.

3. The interface system of claim 1, wherein the control circuitry is adapted to control a height at which the avatar performs at least one virtual activity of jumping and hopping based at least in part upon an elapsed time between a first detected footfall of the user and a second detected footfall of the user.

4. The interface system of claim 1, wherein the control circuitry is adapted to control a height at which the avatar performs at least one virtual activity of jumping and hopping based at least in part upon a detected force magnitude of at least one detected footfall of the user.

5. The interface system of claim 1, wherein the user interface comprises:
a ground level pad adapted to be stepped on by the user, the ground level pad having a left sensor region and a right sensor region defined therein; and
at least one sensor disposed within each of the left sensor region and the right sensor region of the ground level pad.

6. The interface system of claim 5, wherein the user interface further comprises:
a step-up level pad adapted to be stepped on by the user and disposed above the ground level pad, the step-up level pad having a left sensor region and a right sensor region defined therein; and
at least one sensor disposed within each of a left sensor region and a right sensor regions of the step-up level pad.

7. The interface system of claim 1, wherein the user interface comprises at least one sensor coupled to a pair of articles of footwear adapted to be worn by the user.

8. The interface system of claim 7, wherein the at least one sensor is integrated into a resilient underside of each of the pair of articles of footwear.

9. The interface system of claim 7, wherein the host computer is a portable computing device adapted to be held in the hands of the user.

10. The interface system of claim 9, wherein the host computer is interfaced to the at least one sensor of pair of articles of footwear by a wireless communication connection.

11. The interface system of claim 1, wherein the plurality of physical activities include all of walking, running, and jumping.

12. The interface system of claim 1, wherein at least one of the plurality of sensors is an analog sensor.

13. The interface system of claim 1, wherein at least one of the plurality of sensors is a contact switch adapted to detect a presence of a user's foot within a sensor region of the user interface.

14. The interface system of claim 1, wherein at least one of the plurality of sensors is a pressure sensor adapted to detect an amount of force applied by a user's foot within a sensor region of the user interface.

15. The interface system of claim 1, wherein the host computer is adapted to drive the display to present a first person view or a third person view of the avatar within the virtual environment.

16. The interface system of claim 1, wherein the control circuitry is arranged within the user interface, is arranged within the host computer, or is distributed across the user interface and the host computer.

17. The interface system of claim 1, further comprising a hand-piece adapted to be held by the user and generate hand-piece data when engaged by the user, wherein
the control circuitry is further adapted to control actions of the avatar within the virtual environment based on the hand-piece data.

18. The interface system of claim 17, wherein the control circuitry is adapted to control a direction in which the avatar performs at least one virtual activity of walking, jogging, running, jumping, and hopping based at least in part upon input provided by the user to the hand-piece.

19. A human computer interface method, comprising:
detecting footfalls of a user's feet with a plurality of sensors;
generating sensor signals corresponding to the detected footfalls;
identifying, based on the sensor signals, a physical activity being currently performed by the user among a plurality of physical activities based at least in part upon at least one of a sequence and a timing of detected footfalls of the user, the plurality of physical activities including at least two of standing, walking, jumping, hopping, jogging, and running;
controlling an avatar within a virtual environment to perform one of a plurality of virtual activities based at least in part upon the identified current physical activity of the user, the plurality of virtual activities including at least two of standing, walking, jumping, hopping, jogging, and running; and
driving a display to present a view to the user of the avatar performing the virtual activity within the virtual environment.

20. The interface method of claim 19, wherein the controlling comprises controlling a speed at which the avatar performs at least one virtual activity of walking, jogging, and running based at least in part upon the rate of detected footfalls of the user.

21. The interface method of claim 19, wherein the controlling comprises controlling a height at which the avatar performs at least one virtual activity of jumping and hopping based at least in part upon an elapsed time between a first detected footfall of the user and a second detected footfall of the user.

22. The interface method of claim 19, wherein the controlling comprises controlling a height at which the avatar performs at least one virtual activity of jumping and hopping based at least in part upon a detected force magnitude of at least one detected footfall of the user.

23. The interface method of claim 19, wherein the detecting comprises detecting a presence of a user's foot within a sensor region of a user interface.

24. The interface method of claim 19, wherein the detecting comprises detecting an amount of force applied by a user's foot within a sensor region of a user interface.

25. The interface method of claim 19, wherein the plurality of physical activities include all of walking, running, and jumping.

26. The interface method of claim 19, wherein generating the sensor data comprises generating an analog signal.

27. The interface method of claim 19, further comprising driving the display to present a first- or a third-person view of the avatar within the virtual environment.

28. The interface method of claim 19, further comprising:
detecting a user's engagement with a hand-piece;
generating hand-piece data corresponding to an engagement detected; and
controlling the at least one action of the avatar within the virtual environment based on the hand-piece data.

29. The interface system of claim 19, further comprising identifying the detected physical activity by determining at least one of a timing, a frequency, a duty cycle, and a magnitude of a characteristic pattern contained within the sensor signals.

30. The interface method of claim 29, wherein the controlling comprises controlling a direction in which the avatar performs at least one virtual activity of walking, jogging, running, jumping, and hopping based at least in part upon input provided by the user to the hand-piece.

31. A human computer interface system, comprising:
a user interface comprising a plurality of sensors, the sensors adapted to detect footfalls of a user's feet and generate corresponding sensor signals;
a host computer communicatively coupled to the user interface, the host computer adapted to manage a virtual environment containing an avatar associated with the user; and
control circuitry adapted to control the avatar within the virtual environment to perform at least one of a plurality of virtual activities based at least in part upon at least one of a sequence and timing of detected footfalls of the user, the plurality of virtual activities comprising at least two of standing, walking, jumping, hopping, jogging, and running, wherein the host computer is further adapted to drive a display to present a view to the user of the avatar performing the at least one virtual activity within the virtual environment.

32. The interface system of claim 31, wherein the control circuitry is adapted to control a speed at which the avatar performs at least one virtual activity of walking, jogging, and running based at least in part upon the rate of detected footfalls of the user.

33. The interface system of claim 31, wherein the control circuitry is adapted to control a height at which the avatar performs at least one virtual activity of jumping and hopping based at least in part upon an elapsed time between a first detected footfall of the user and a second detected footfall of the user.

34. The interface system of claim 31, wherein the control circuitry is adapted to control a height at which the avatar performs at least one virtual activity of jumping and hopping based at least in part upon a detected force magnitude of at least one detected footfall of the user.
